(19) United States
(12) Patent Application Publication
(10) Pub. No.: US 2026/0199067 A1
(43) Pub. Date: Jul. 16, 2026

(54) MODULAR ASSEMBLAGE AND KIT FOR SURGICAL EVACUATION

(71) Applicant: INTER-MED, INC., Racine, WI (US)

(72) Inventors: Brett ARAND, Racine, WI (US); Allen A. NASSEH, Racine, WI (US)

(21) Appl. No.: 19/131,427

(22) PCT Filed: Nov. 22, 2023
(86) PCT No.: PCT/US2023/080886

§ 371 Date: May 20, 2025

Related U.S. Application Data
(60) Provisional application No. 63/427,719, filed on Nov. 23, 2022.

(51) Int. Cl. A61C 17/02; A61C 5/40; A61C 5/82

(52) U.S. Cl. CPC A61C 17/0208; A61C 5/40; A61C 5/82

(57) ABSTRACT

A modular assemblage and kit is used during dental procedures. Depending on the clinical procedure being performed, an operator can connect various elements of the kit in sequential or simultaneous fashion to accomplish various tasks to help simplify the procedure and operation. In some embodiments, the kit allows for single-handed endodontic irrigation and evacuation.

### CROSS-REFERENCE TO RELATED APPLICATIONS

This application claims the benefit of U.S. Provisional Application No. 63/427,719, filed Nov. 23, 2022; the entire contents of this application are hereby incorporated by reference herein.

### BACKGROUND

The inner portion of a tooth includes a pulp cavity that contains soft living tissue, or the “pulp,” of the tooth. The pulp includes connective tissue, blood vessels, cells, and nerve endings. The pulp cavity includes an upper pulp chamber and root canals that extend to the apex or apical section of the tooth deeper in the jaw. The outer (visible) portion of the tooth is referred to as the crown and has a covering of enamel. The hard enamel protects softer dentinal tissues in the upper portion of the tooth. The enamel includes, or consists of, a hard, calcium-based substance, hydroxyapatite. The dentin tissue contains a matrix of minute tubules interspersed with collagen fibers that surround and protect the tooth pulp. The outer (non-visible) portion of the tooth root is covered with cementum, a thin hard tissue that joins the root to the surrounding bone through Sharpey's fibers. Dental decay, or caries, is caused by bacteria accumulating on teeth and forming a biofilm (plaque). The biofilm produces acids that dissolve and weaken the hydroxyapatite of the tooth, thereby causing decay. If the pulp tissue becomes infected and dies, i.e. pulp necrosis, a root canal treatment is required. During root canal treatment, the tooth is instrumented for access to the root canal system, the pulp tissue removed, and the root canal system is cleaned and disinfected. Once the canal is clean, it can be obturated or filled. Typically, endodontic and/or root canal procedures are performed by a dentist or endodontist and their assistant. Because two individuals are usually involved in these procedures, the phrase “four handed dentistry” is often used.

Conventional techniques used to address repair are known including U.S. Pat. No. 9,872,748 that discloses a method for evacuating a tooth with multiple different evacuation cannulas. Similarly, U.S. Pat. No. 8,827,705 discloses a method where multiple evacuation cannulas are used simultaneously during the evacuating process. U.S. Pat. No. 7,226,288 is also similar and discloses methods for irrigating and evacuating a tooth using various sequential evacuation steps and cannulas. There remains a need for improved techniques and instrumentation to improve the process for evacuating a tooth during repair procedures.

### SUMMARY

The present disclosure provides a modular assemblage and kit for use in dental treatments, particularly for use in endodontic procedures, such as root canal therapy. The device is utilized during instrumentation and irrigation of the root canal by providing both fluid irrigation/lubrication delivery and evacuation in a simpler, more effective, and modular fashion than existing art. Additionally, the disclosure can be used during endodontic retreatment procedures. Depending on the clinical procedure being performed, the operator can connect various elements of the assemblage and kit in sequential or simultaneous fashion to accomplish various tasks to help simplify the procedure and operation. More specifically, the kit components can be configured to simultaneously deliver and/or evacuate the fluid at the coronal chamber, within the canal, and at the apex of the canal.

Some configurations are advantageously hands free, may advantageously require only one of the operator's hands, or may require two handed operation. Irrigation is supplied by an attached syringe. Evacuation is facilitated by the standard dental vacuum present in most dental operatories to which the disclosed device removably makes fluid contact with. Single handed operation is achieved by a suction manifold that attaches to the irrigant delivery tip which allows for simultaneous fluid delivery and fluid evacuation. Single handed operation is advantageous in situations where dental professionals practice solo or in situations when a dental assistant is not available (for example, in dental schools) as the present disclosure simplifies the procedure and operation to a single individual. In such situations, the use of the disclosed device may allow a single practitioner to comfortably complete procedures that would otherwise typically include an assistant (i.e. procedures that usually require four handed dentistry). Various tips are provided for coronal and apical irrigant delivery and evacuation with specific gauges of cannula to balance high flow with various access depths.

### BRIEF DESCRIPTION OF THE DRAWINGS

The drawings illustrate the best mode presently contemplated of carrying out the disclosure.

FIG. 1 depicts an endodontic treatment kit for use during instrumentation and irrigation stages of a root canal therapy on a tooth, the kit including a high-volume evacuator, a surgical suction adapter operably coupled with the high-volume evacuator, a tubing assembly, and a wye HVE fitting coupled with a first end of the tubing assembly;

FIG. 2 depicts a manifold at one bifurcated end of the tubing assembly, the manifold formed to include an internal chamber to receive a short delivery dental tip therein to deliver irrigants to the tooth;

FIG. 3 depicts a handpiece at another bifurcated end of the tubing assembly, the handpiece coupled with an evacuation tip that evacuates fluid from the tooth;

FIG. 4 depicts the wye HVE fitting connected with the tubing assembly at the first end thereof;

FIG. 5 depicts the manifold of FIG. 2 with a long tip received in the internal chamber to deliver irrigants deeper into the tooth;

FIG. 6 depicts the handpiece of FIG. 3 coupled with the long tip of FIG. 5 that evacuates fluid from deeper within the tooth;

FIG. 7 depicts the surgical suction adapter of FIG. 1 including an O-ring that seals with the high-volume evacuator while the surgical suction adapter and the high-volume evacuator are coupled together;

FIG. 8 depicts the high-volume evacuator of FIG. 1 coupled with a dental office vacuum line configured to evacuate fluid and/or debris from the tooth;

FIG. 9 depicts the high-volume evacuator coupled with the dental office vacuum line at a first end of the high-volume evacuator and coupled with the surgical suction adapter at a second end of the high-volume evacuator;

FIG. 10 depicts the wye HVE fitting of FIG. 4 coupled with the dental office vacuum line to fluidly connect the dental office vacuum line with the tubing assembly;

FIG. 11 depicts the high-volume evacuator coupled with the dental office vacuum line at the first end of the high-volume evacuator and coupled with the surgical suction adapter at the second end of the high-volume evacuator, and further depicting the surgical suction adapter coupled with the wye HYE fitting to fluidly connect the dental office vacuum line with the tubing assembly;

FIG. 12 depicts the manifold and the short delivery dental tip of FIG. 2, and further depicts a syringe coupled with the short delivery dental tip to provide irrigants to the short delivery dental tip and the tooth;

FIG. 13 depicts the manifold, the short delivery dental tip, and the syringe of FIG. 12 that delivers irrigants to the tooth through the short delivery dental tip and evacuates fluid from the tooth through an evacuation opening formed in the manifold, and further depicts the evacuation tip extending into the tooth to evacuate additional fluid from the tooth;

FIG. 14 depicts the manifold, the short delivery dental tip, and the syringe of FIG. 12 that delivers irrigants to the tooth through the short delivery dental tip and evacuates fluid from the tooth through the evacuation opening formed in the manifold, and further depicts the long tip of FIG. 5 extending into the tooth to evacuate addition fluid from deeper within the tooth;

FIG. 15 depicts the long tip of FIG. 6 coupled with the manifold and extending into the tooth to delivery irrigants deeper into the tooth;

FIG. 16 depicts the kit of FIG. 1 including a wye HVE fitting that is separable from the tubing assembly through a luer fitting;

FIG. 17 depicts the luer fitting that removably couples the wye HVE fitting with the tubing assembly, and further depicts the suction surgical adapter of FIG. 7 including the O-ring;

FIG. 18 depicts the wye HVE fitting coupled with the dental office vacuum line at a first end of the wye HVE fitting and the wye HVE fitting coupled with the luer fitting at a second end of the wye HVE fitting;

FIG. 19 depicts the wye HVE fitting coupled with the high-volume evacuator at the first end of the wye HVE fitting and the wye HVE fitting coupled with the luer fitting at the second end of the wye HVE fitting;

FIG. 20 depicts an alternative luer fitting including a luer to barb fitting and a barb to barb wye fitting;

FIG. 21A depicts the surgical suction adapter and the wye HVE fitting integrally formed;

FIG. 21B depicts the surgical suction adapter of FIG. 17 without the O-ring;

FIG. 22 depicts another endodontic treatment kit, the kit including a dental dam clamp and a plurality of clips that are removably coupled with the dental dam clamp to maintain a position of cannulas relative to the tooth;

FIG. 23 depicts the plurality of clips coupled with the dental dam clamp and a cannula extending through each of the clips to provide irrigation and evacuation;

FIG. 24 depicts the cannulas extending into the tooth to provide irrigation and evacuation and the evacuation tip of FIG. 3 extending into the tooth to provide additional evacuation of fluid from the tooth;

FIG. 25 depicts the cannulas extending into the tooth to provide irrigation and evacuation and the long tip of FIG. 6 extending into the tooth to provide additional evacuation of fluid from the tooth;

FIG. 26 depicts an evacuation hood included in the kit that is coupled with the dental dam clamp and configured to catch fluid;

FIG. 27 depicts two dental dam clamps with a clip coupled to each dental dam clamp, and further depicting that each dental dam clamp is formed to include two wings that each have a hole extending therethrough;

FIG. 28A depicts one of the plurality of clips formed to include a cannula channel that receives the cannula therethrough and a clamp channel sized to receive a portion of the dental dam clamp therein;

FIG. 28B depicts a top view of the one of the plurality of clips of FIG. 28A;

FIG. 28C depicts a left side view of the one of the plurality of clips of FIG. 28A;

FIG. 28D depicts a right side view of the one of the plurality of clips of FIG. 28A showing that the cannula channel extends through the clip at an angle;

FIG. 28E depicts a front view of the one of the plurality of clips of FIG. 28A showing the cannula channel extending through a portion of the clip;

FIG. 28F depicts a rear view of the one of the plurality of clips of FIG. 28A;

FIG. 28G depicts a bottom view of the one of the plurality of clips of FIG. 28A;

FIG. 29A depicts a top view of the dental dam clamp and an alternative clip that extends through the hole formed in the wing of the dental dam clamp to maintain a position of the cannula relative to the tooth;

FIG. 29B depicts the clip of FIG. 29A extending through the hole of the dental dam clamp and the clip coupled with the cannula;

FIG. 29C depicts a front view of the dental dam clamp;

FIG. 29D depicts a front view of the dental dam clamp coupled with the clip and the cannula;

FIG. 30 depicts an alternative clip that couples the evacuation hood of the kit with the dental dam clamp and a suction cannula extending through a rear portion of the evacuation hood; and

FIG. 31 depicts the clip of FIG. 30 that couples the evacuation hood of the kit with the dental dam clamp and the suction cannula extending through a side portion of the evacuation hood.

### DETAILED DESCRIPTION

The following paragraphs define in more detail the embodiments of the invention described herein. The following embodiments are not meant to limit the invention or narrow the scope thereof, as it will be readily apparent to one of ordinary skill in the art that suitable modifications and adaptations may be made without departing from the scope of the invention, embodiments, or specific aspects described herein.

The present disclosure describes an endodontic treatment kit (100) for use during the instrumentation and irrigation stages of a root canal therapy on a tooth (44). The kit (100) may be configured to simultaneously or sequentially deliver and/or evacuate fluid at a coronal chamber, within a canal, and/or at an apex of the canal.

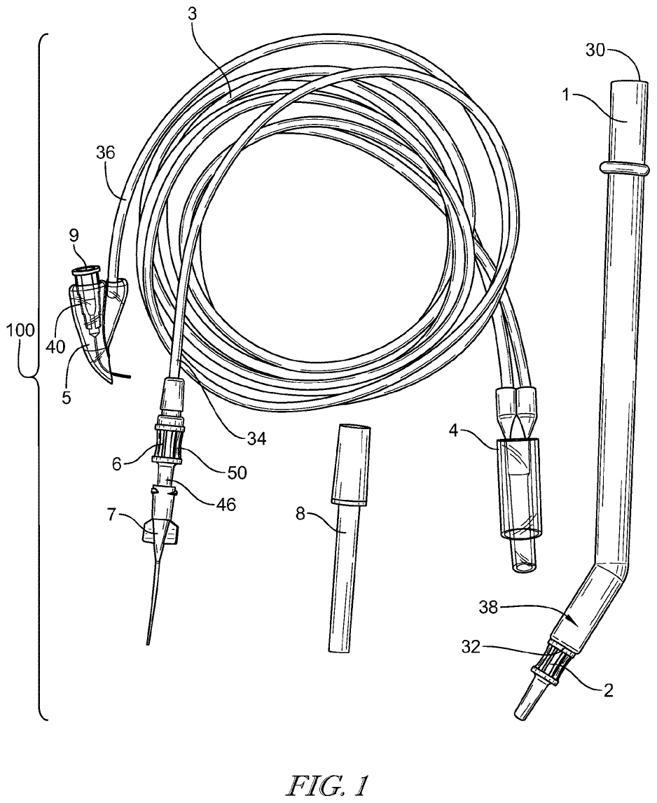

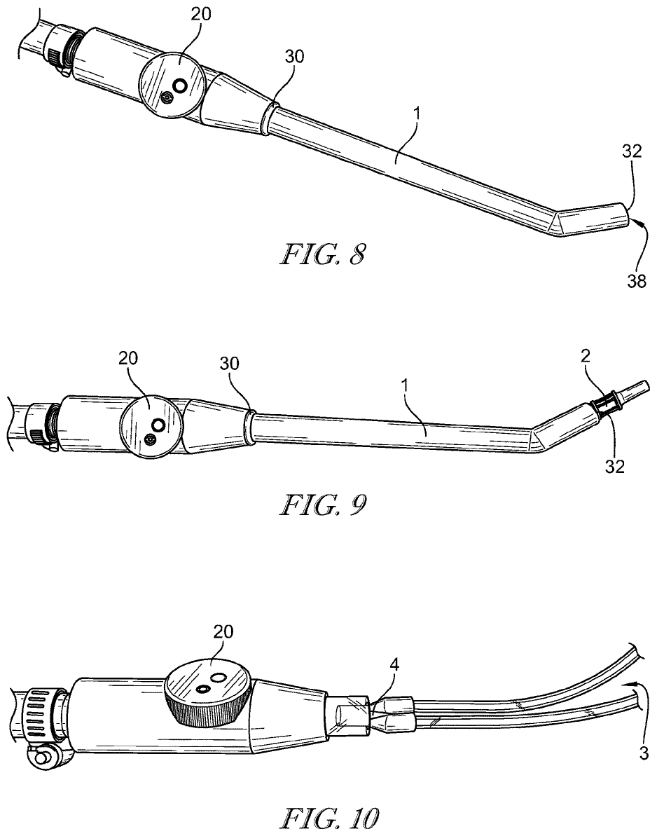

An exemplary kit (100) is shown in FIG. 1. The kit (100) includes a high-volume evacuator (1), a surgical suction adapter (2), a tubing assembly (3), and a wye HVE fitting (4). The high-volume evacuator (1) includes a first end (30) and a second end (32) opposite the first end (30). The first end (30) may be removably coupled with a dental office vacuum line (20) as shown in FIGS. 8 and 9. The second end (32) of the high-volume evacuator (1) may be coupled with the surgical suction adapter (2) as shown in FIGS. 1, 9, and 11. The surgical suction adapter (2) is inserted into an evacuation orifice (38) formed in the second end (32) of the high-volume evacuator (1).

The tubing assembly (3) removably attaches to the high-volume evacuator (1) and the dental office vacuum lines (20) through the wye HVE fitting (4) as shown in FIG. 11. In some embodiments, the HVE fitting (4) is fixed to the tubing assembly (3) as shown in FIG. 1. In other embodiments, the HVE fitting (4) is removable from the tubing assembly (3) as shown in FIG. 16. The surgical suction adapter (2) may be coupled with the wye HVE fitting (4) as shown in FIG. 11 to fluidly connect the dental office vacuum line (20) with the tubing assembly (3). The HVE fitting (4) may mount directly to the surgical suction adapter (2) if desired to reduce a number of operatory vacuum lines.

The tubing assembly (3) bifurcates into a first tube (34) and a second tube (36) as shown in FIG. 1. The first tube (34) and the second tube (36) may also be referred to as a first fluid line (34) and a second fluid line (36). The second tube (36) is attached to a manifold (5) included in the kit (100), and the first tube (34) is attached to a handpiece (6) included in the kit (100).

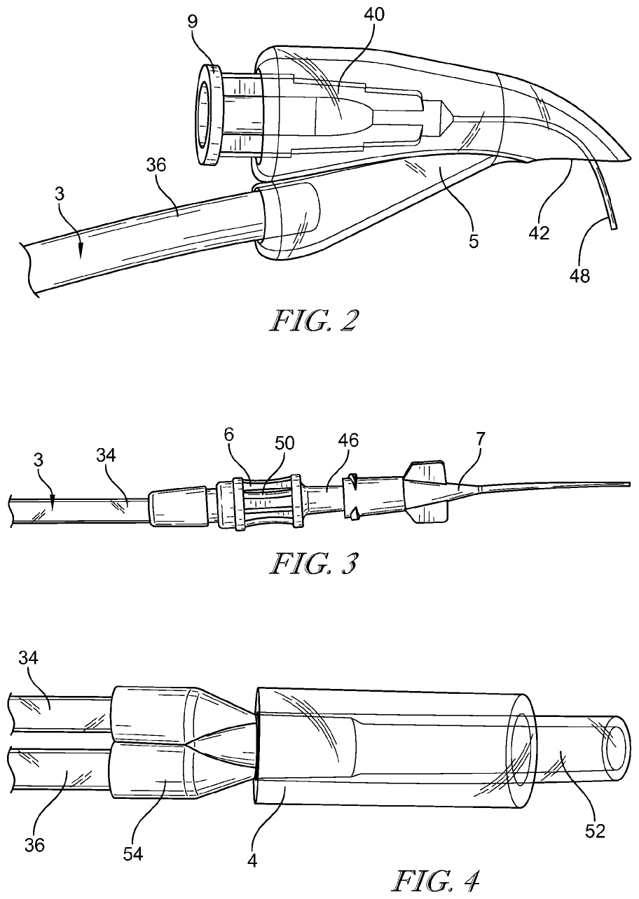

The manifold (5) is configured to be coupled with a first tip (9) as shown in FIG. 1. For example, the first tip (9) may be a short delivery dental tip (9). The manifold (5) is formed to include an internal chamber (40) sized to receive the short delivery dental tip (9) therein as shown in FIG. 2. The manifold (5) extends entirely around the short delivery dental tip (9) while the short delivery dental tip (9) is received within the internal chamber (40). A distal end of the manifold (5) provides an evacuation opening (42) to the tubing assembly (3) that evacuates fluid when placed at or near a crown of the tooth (44). The dental office vacuum lines (20) provide suction (i.e., evacuation) through the tubing assembly (3) that evacuates fluid from the tooth (44) via the evacuation opening (42). The tubing assembly (3) preferably comprises tubing with an outer diameter between about 1.5 mm and about 6.5 mm.

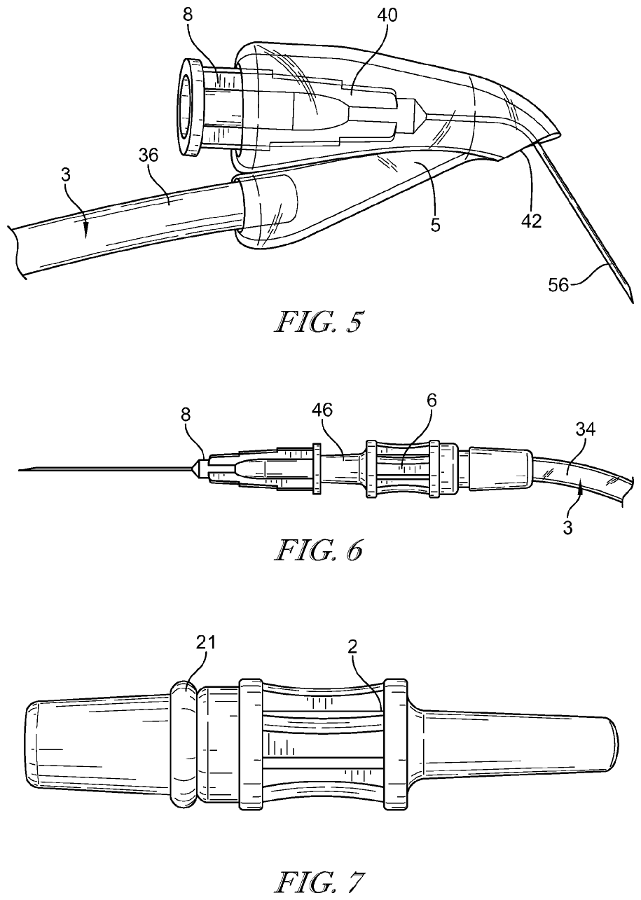

The handpiece (6) terminates with a male luer fitting (46) that accepts standard dental tips that have female luer fittings, such as a second tip (7). The second tip (7) may be a plastic evacuation tip (7). The plastic evacuation tip (7) evacuates fluid away from the tooth (44). In some embodiments, the kit (100) includes a third tip (8) for delivery or evacuation at an apex of the canal. The third tip (8) may be a long dental tip (8) that reaches further within the canal that the first tip (9) or the second tip (7). The long dental tip (8) may be mounted in the internal chamber (40) of the manifold (5), as shown in FIG. 5, or on the handpiece (6), as shown in FIG. 6.

In certain embodiments, the surgical suction adapter (2) and the handpiece (6) are comprised of the same molded part and may optionally include an O-ring (21) as shown in FIG. 7. In some embodiments, the kit (100) may not include any tips as any similar tips in the market may be used with the kit (100). In some embodiments, the kit (100) includes the tubing assembly (3) only so that the procedure can be pieced together by the operator to fit their particular needs.

FIG. 2 shows the short delivery dental tip (9) inserted into the internal chamber (40) of the manifold (5) and a cannula (48) of the short delivery dental tip (9) bent to approximately 100 degrees. Depending on the tooth (44) subjected to treatment, other bend angles between about 60 degrees and about 140 degrees may be utilized for the short delivery dental tip (9). In certain embodiments, the cannula (48) of the short delivery dental tip (9) is between about 18 gauge and about 27 gauge. The cannula (48) extends about 5 mm to about 15 mm beyond the evacuation opening (42) of the manifold (5). In some embodiments, the short delivery dental tip (9) is comprised of at least one metal cannula (48), although the cannula (48) may comprise a combination of different metal and/or polymeric/plastic materials. Suitable metal and polymeric/plastic materials include stainless steel, aluminum, steel, brass, titanium, polyimide, polyether ether ketone (PEEK), polyaryletherketone (PAEK), polyethylene (PE), polypropylene (PP), acrylonitrile butadiene styrene (ABS), polyvinyl chloride (PVC), polytetrafluoroethylene (PTFE), amongst others.

In some embodiments, the manifold (5) is made from an elastomeric material, for example, silicone having a hardness between shore 30 and shore 80. Suitable elastomeric materials include natural rubbers, styrene-butadiene block copolymers, polyisoprene, polybutadiene, ethylene propylene rubber, ethylene propylene diene rubber, silicone elastomers, fluoroelastomers, polyurethane elastomers, nitrile rubbers, amongst others. In some embodiments, the manifold (5) has an inlet inner diameter of between about 0.5 mm and about 2.0 mm and is configured to evacuate fluid at a rate of at least 50 mL/min when using a typical dental vacuum system, such as the dental office vacuum line (20) (which is usually between 5 inHg and 30 inHg, but can vary).

FIG. 3 shows the plastic evacuation tip (7) coupled with the handpiece (6). In some embodiments, the plastic evacuation tip (7) includes varying diameters to provide a taper along a length of the plastic evacuation tip (7) that enters the root canal of the tooth (44). In some embodiments, the plastic evacuation tip (7) has an inlet inner diameter of between about 0.1 mm to about 0.8 mm and is configured to evacuate fluid at a rate of at least 10 mL/min when using a typical dental vacuum system, such as the dental office vacuum line (20).

In some embodiments, the handpiece (6) includes two tapered ends. A first tapered end includes a 6% ISO luer taper per ISO 80369-7:2021. In some embodiments, a second tapered end has a diameter between about 3.5 mm and about 10 mm, which allows the handpiece (6) to serve multifunctional purposes within the disclosed kit (100) as either the handpiece (6) or the surgical suction adapter (2). In some embodiments, only the first tapered end (i.e., the male luer fitting (46) end) is tapered so that the first tapered end may be connected to treatment tips (7), (8), and the second tapered end is not tapered.

For example, if the second tapered end is not intended to be used as the surgical suction adapter (2), the second tapered end does not need to be tapered. Optionally, the handpiece (6) may contain ridges (50) or other means to improve operator grip and handling as shown in FIG. 3. In some embodiments, the handpiece (6) is between about 20 mm and about 65 mm in length. In some embodiments, the handpiece (6) is between about 30 mm and about 45 mm in length. In illustrative embodiments, the handpiece (6) is injection molded from a suitable thermoplastic resin, or other suitable materials, such as elastomers for a softer grip or metals for a reusable part.

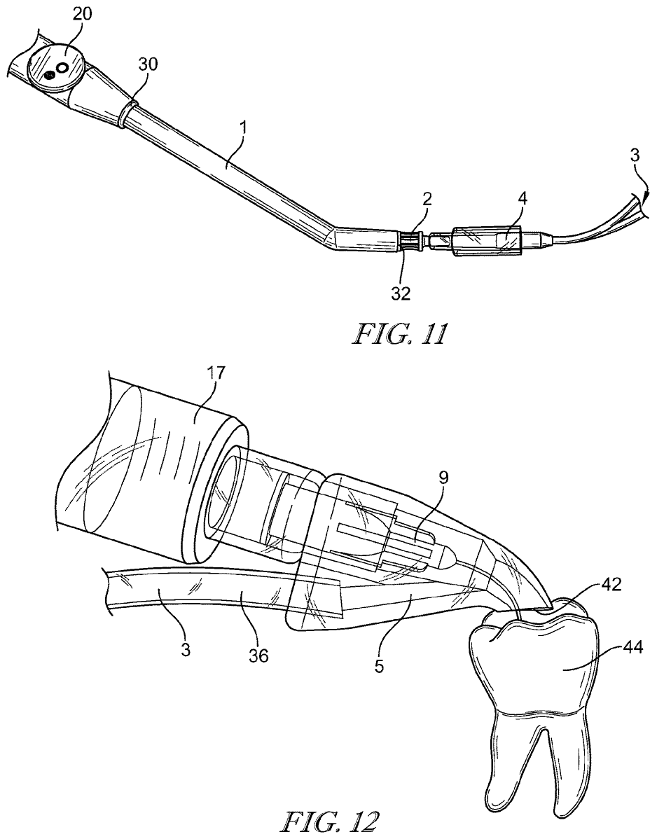

FIG. 4 shows the wye HVE fitting (4). The molded part of the wye HVE fitting (4) that bifurcates the tubing assembly (3) into the first tube (34) and the second tube (36) also fits into a larger diameter tubing that is used to mate with the dental office vacuum line (20) as shown in FIG. 10. If the tubing assembly (3) is not bifurcated, the smaller diameter tubing is bonded directly into the larger diameter tubing making up the HVE fitting (4). In some embodiments, the wye HVE fitting (4) is between about 15 mm and about 35 mm in length. The wye HVE fitting (4) is formed to include a single outer port (52) and a bifurcated port (54) as shown in FIG. 4. In certain embodiments, the single outer port (52) of the wye HVE fitting (4) preferably has an outer diameter between about 6 mm and about 15 mm, while each bifurcated port (54) preferably has an inner diameter between about 2 mm and about 6 mm. In some embodiments, the wye HVE fitting (4) is injection molded from a suitable thermoplastic resin or any other suitable material, such as, but not limited to thermoset plastics, rubbers, or metals for a reusable part.

FIG. 5 shows the long dental tip (8) mounted in the internal chamber (40) of the manifold (5) for apical irrigant delivery and a cannula (56) of the long dental tip (8) bent to approximately 100 degrees.

Depending on the tooth (44) subjected to treatment, other bend angles between about 60 degrees and about 140 degrees may be utilized for the long dental tip (8). In certain embodiments, the cannula (56) of the long dental tip (8) is preferably between about 23 gauge and about 31 gauge. In some embodiments, the cannula (56) extends about 10 mm to about 25 mm beyond the evacuation opening (42) of the manifold (5). Preferably, the long dental tip (8) comprises at least one metal cannula (56), although the cannula (56) may comprise a combination of different metal and/or polymeric/plastic materials. Suitable metal and polymeric/plastic materials include stainless steel, aluminum, steel, brass, titanium, polyimide, polyether ether ketone (PEEK), polyaryletherketone (PAEK), polyethylene (PE), polypropylene (PP), acrylonitrile butadiene styrene (ABS), polyvinyl chloride (PVC), polytetrafluoroethylene (PTFE), amongst others. FIG. 6 shows the long dental tip (8) mounted on the handpiece (6) for apical evacuation. When used for evacuation, the long dental tip (8) may have an evacuation rate of 0.5 mL/min to about 6.0 mL/min depending on the cannula (56) gauge when using a typical dental vacuum system, such as the dental office vacuum line (20).

FIG. 7 shows the surgical suction adapter (2). The surgical suction adapter (2) includes the O-ring (21) to seal with the high-volume evacuator (1) when the surgical suction adapter (2) and the high-volume evacuator (1) are coupled with one another. In some embodiments, the O-ring (21) has a hardness between about shore 40 and about shore 70. The surgical suction adapter (2) steps down the suction inlet size for more precise suction of fluids. In some embodiments, a first end of the surgical suction adapter (2) is configured as a male luer fitting so that a mating female luer or appropriately sized tubing can be used to mate to other parts of the kit, for example, as shown in FIG. 11. In some embodiments, the O-ring (21) may not be included, as shown in FIG. 21B, if the surgical suction adapter (2) is molded to fit tight enough with the high-volume evacuator (1) to create a seal without a soft material or is dual molded with a softer material to make the seal.

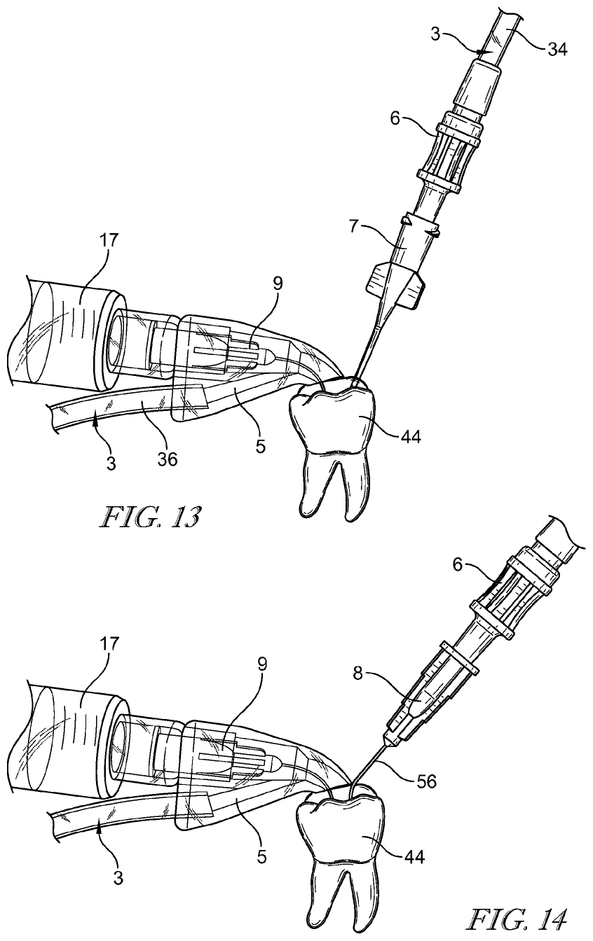

The short delivery dental tip (9) may be coupled with a syringe (17) as shown in FIG. 12. FIG. 12 shows the manifold (5) and short delivery dental tip (9) in usage on the tooth (44). The short delivery dental tip (9) delivers irrigant coronally or in the coronal third of the root canal via the syringe (17), while the manifold (5) evacuates fluid at the crown of the tooth through the evacuation opening (42). The configuration as shown in FIG. 12 may be used during instrumentation providing lubricant and medicament. The configuration as shown in FIG. 12 may also be used in conjunction with the handpiece (6) and the plastic evacuation tip (7) as shown in FIG. 13. The plastic evacuation tip (7) suctions fluid and debris from the canal and the coronal chamber of the tooth (44). As shown in FIG. 14, the plastic evacuation tip (7) may be replaced with the long dental tip (8) to suction at the apex of the tooth (44), also known as at a working length of the tooth (44).

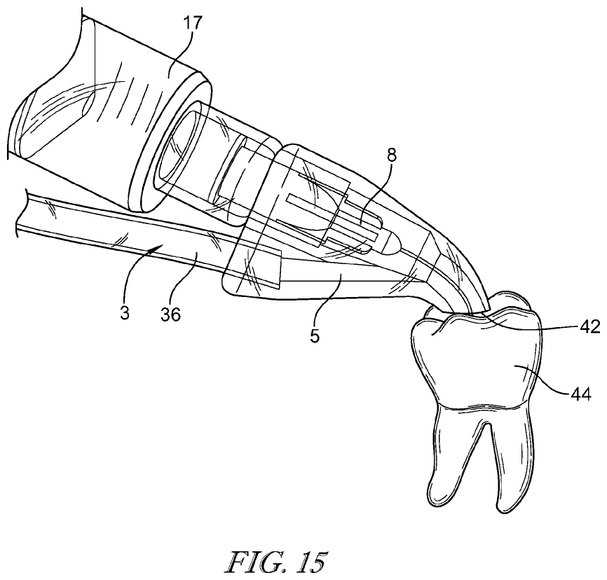

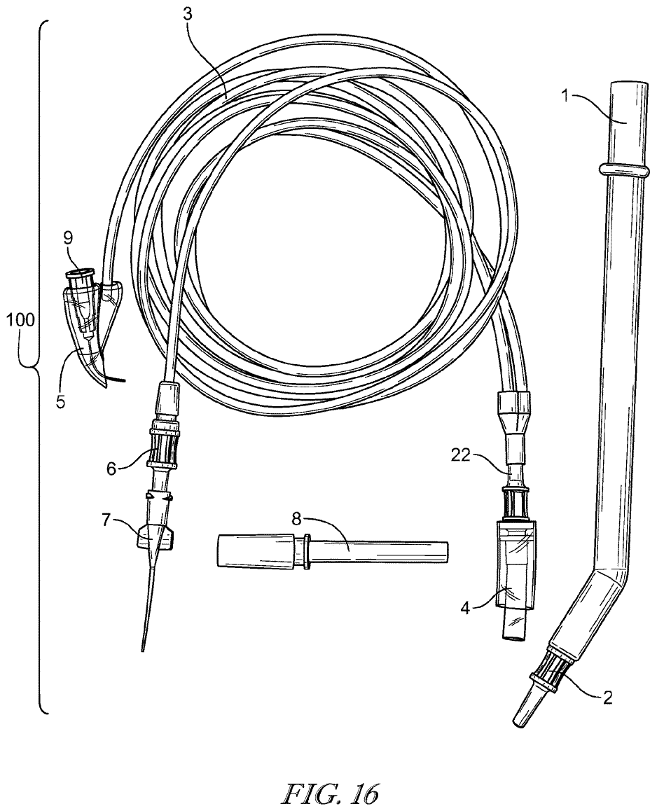

As shown in FIG. 15, the short delivery dental tip (9) may be replaced with the long dental tip (8). The long dental tip (8) is inserted into the manifold (5) to deliver irrigant at the apex of the tooth (44) while simultaneously evacuating the fluid at the crown of the tooth (44) through the evacuation opening (42) of the manifold (5). The configuration as shown in FIG. 15 is referred to as a single handed irrigation which allows a user to simultaneously irrigate at the apex of the root while evacuating excess fluid at the crown, thereby freeing up an operator's or assistant's hand for other actions.

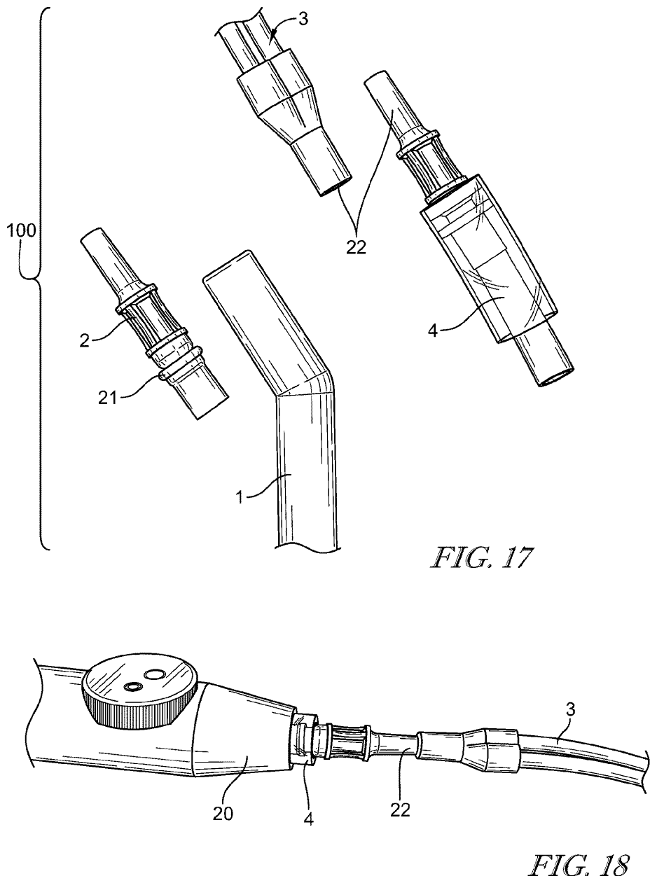

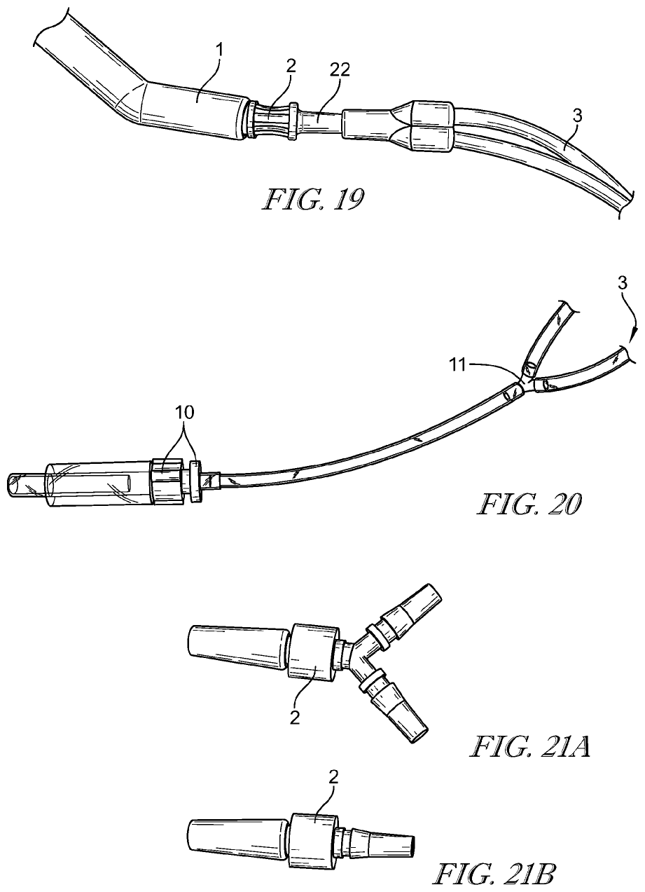

FIG. 16 shows the kit (100) further comprising a luer fitting (22). The HVE fitting (4) is separable from the tubing assembly (3) by means of the luer fitting (22) as shown in FIG. 17. In some embodiments, the luer fitting (22) may be custom molded as shown in FIGS. 17, 18, and 19. In some embodiments, the luer fitting (22) may comprise common luer to barb fittings (10) and barb to barb wye fittings (11) as shown in FIG. 20.

In some embodiments, the surgical suction adapter (2) and the HVE fitting (4) may be formed as an integral component as shown in FIG. 21A. In some embodiments, the surgical suction adapter (2) is formed without the O-ring (21) such that the surgical suction adapter (2) fits tightly with the high-volume evacuator (1) without the O-ring (21) as shown in FIG. 21B.

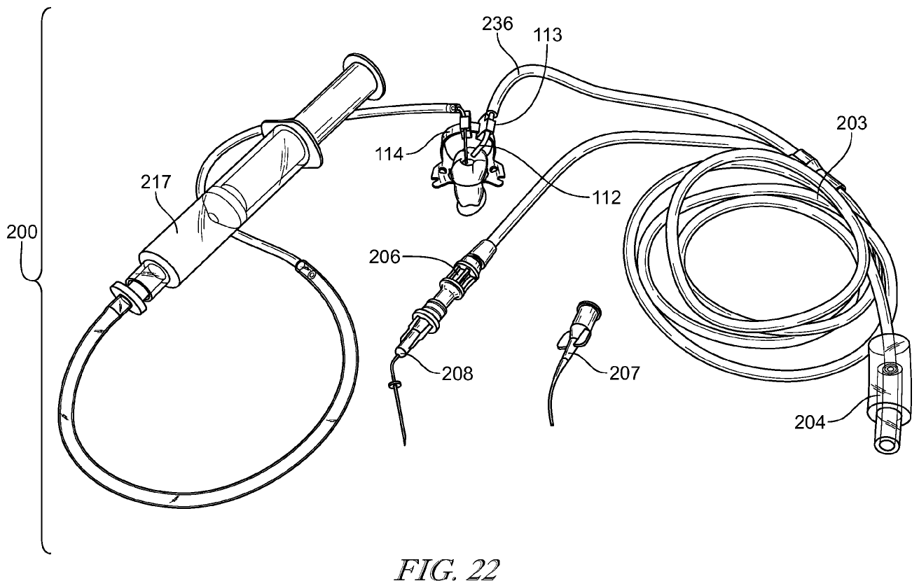

Another embodiment of an endodontic treatment kit (200) is shown in FIG. 22. The endodontic treatment kit (200) is substantially similar to the endodontic treatment kit (100) shown in FIGS. 1-21 and described herein. Accordingly, similar reference numbers indicate features that are common between the endodontic treatment kit (200) and the endodontic treatment kit (100). The description of the endodontic treatment kit (100) is incorporated by reference to apply to the endodontic treatment kit (200), except in instances when it conflicts with the specific description and the drawings of the endodontic treatment kit (200).

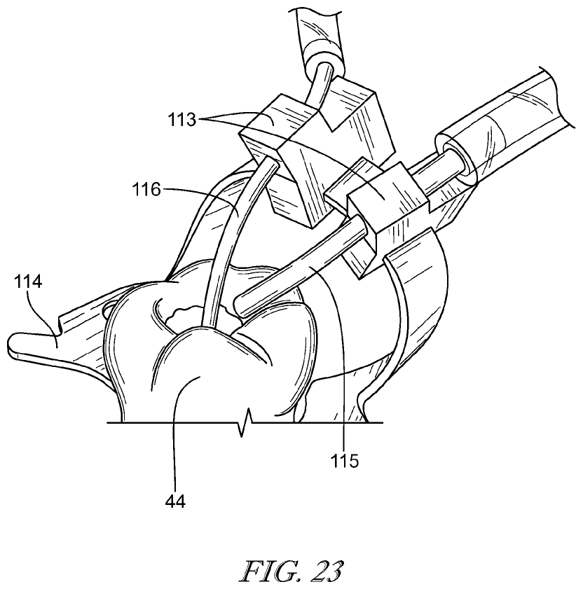

The endodontic treatment kit (200) includes additional hands-free components for improved operator convenience and procedural efficacy. Components of the kit (100) and the kit (200) may be mixed and used with one another. The kit (200) includes irrigation or evacuation cannulas (112), a plurality of clips (113), and a dental dam clamp (114). The cannulas (112) are affixed to the dental dam clamp (114) using the plurality of clips (113). The cannulas (112) may be positioned optimally by moving and/or sliding the plurality of clips (113) along the dental dam clamp (114), rotating the cannulas (112), sliding the cannulas (112) in and out of the plurality of clips (113), and/or bending the cannulas (112) for positioning. The plurality of clips (113) may be positioned anywhere on the dental dam clamp (114) by the operator to ensure adequate visibility during treatment. Illustratively, the cannulas (112) include a suction cannula (115) and a fluid delivery cannula (116) as shown in FIG. 23.

The kit (200) includes a bifurcated tubing assembly (203) with a HVE fitting (204). The bifurcated tubing assembly (203) terminates at a first fluid line (234) with a handpiece (206) and terminates at a second fluid line (236) with the suction cannula (115). The fluid delivery cannula (116) is connected to a syringe 217 as shown in FIG. 22.

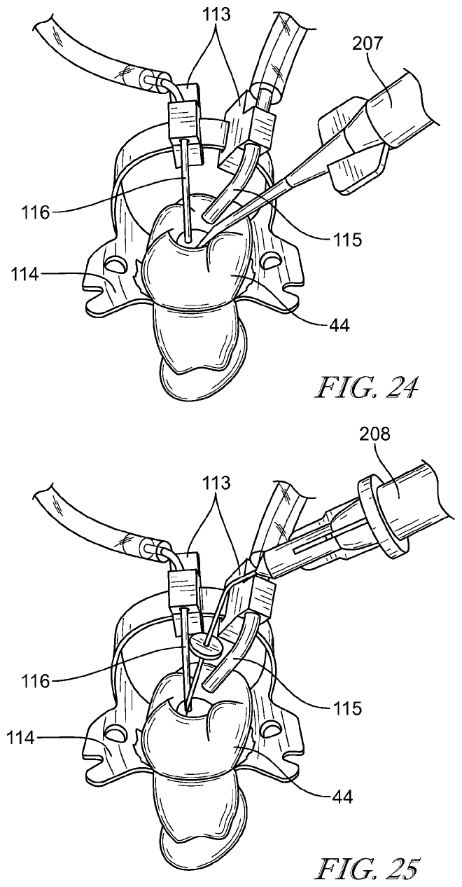

The kit (200) further comprises a plastic evacuation tip (207) and a long tip (208) that may be removably coupled with the handpiece (206) as shown in FIGS. 24 and 25. In some embodiments, the kit (200) may include a tubing assembly that is not bifurcated so as to only include the second fluid line (236) with the suction cannula (115) for attachment to the dental dam clamp (114). The suction cannula (115) may be optimally positioned to suction fluid at the crown of the tooth (44), in the coronal chamber of the tooth (44), or at any location in the canal of the tooth (44). The fluid delivery cannula (116) may be optimally positioned in the coronal chamber of the tooth (44) or at any location in the canal of the tooth (44). Fluid, typically irrigants such as, but not limited to, NaOCI or EDTA, are delivered by manually expressing the syringe (217) such that the fluid is delivered through the fluid delivery cannula (116). A syringe pump may be used instead of or in addition to the syringe (217) for automated delivery of the fluid. If both the delivery and suction cannulas (115, 116) are used simultaneously, as shown in FIGS. 23-25, the fluid delivery cannula (116) may be placed deeper into the tooth (44) than the suction cannula (115). While the cannulas (115, 116) are in place, an additional tip, such as the plastic evacuation tip (207) or the long tip (208), may be mounted on the handpiece (206) to suction fluid deeper in the canal of the tooth (44) as shown in FIGS. 24 and 25.

One of the plurality of clips (113) is coupled to the suction cannula (115), while another of the plurality of clips (113) is coupled to the fluid delivery cannula (116) as shown in FIG. 23. Both of the plurality of clips (113) are coupled with the dental dam clamp (114). The clips (113) hold the cannulas (115, 116) in a fixed position relative to the dental dam clamp (114) and the tooth (44) so that the cannulas (115, 116) may be optimally positioned in a working space within the tooth (44).

The clips (113) may be mounted to dental dam clamps (114) of various sizes or designs, such as those for molar or anterior teeth as shown in FIG. 27. In some embodiments, the clips (113) may be mated to the superior (top) or inferior (bottom; closer to the tooth (44)) portion of the dental dam clamp (114) depending on the clinical procedure and space constraints.

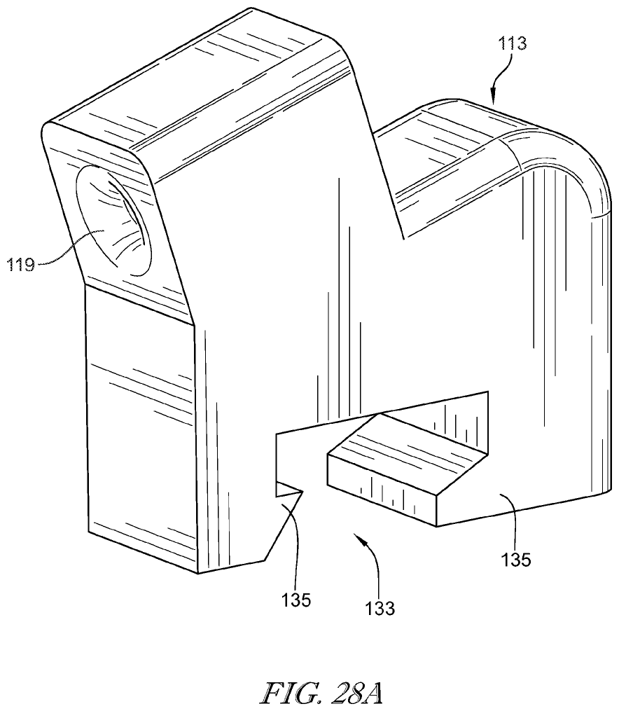

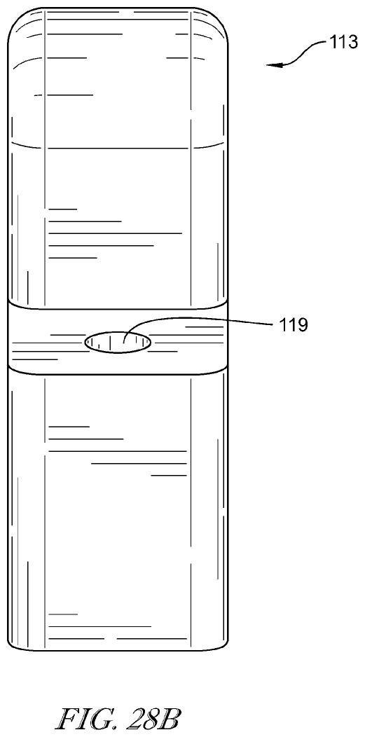

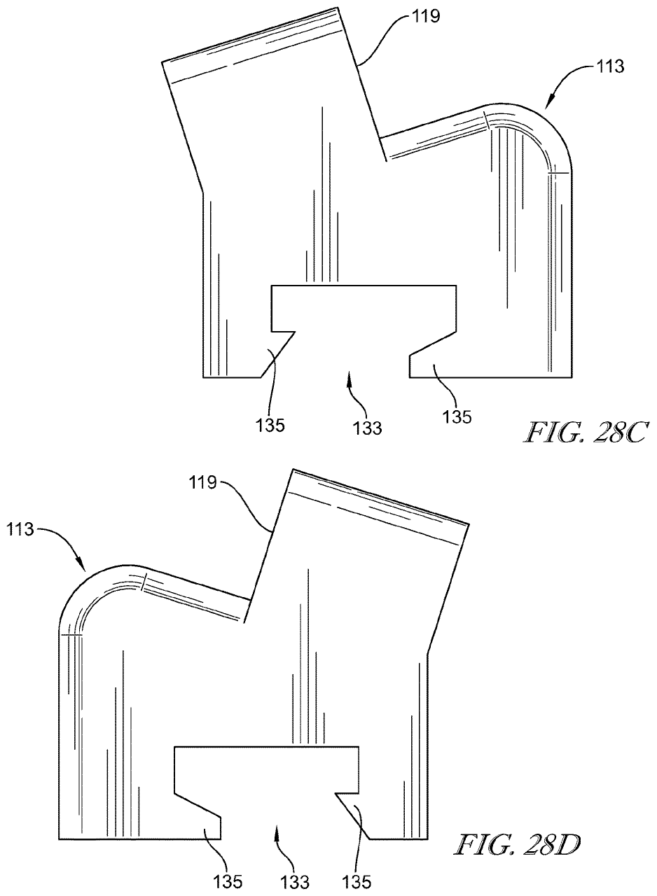

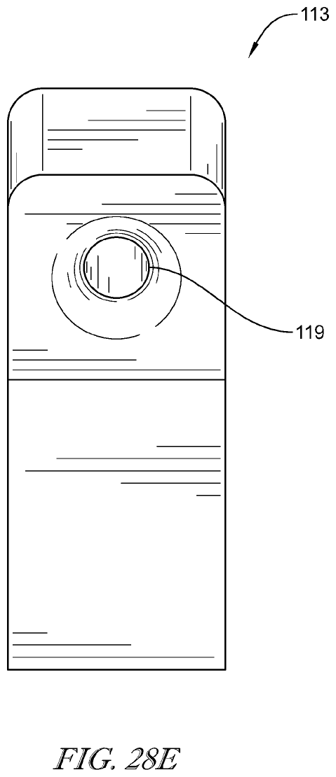

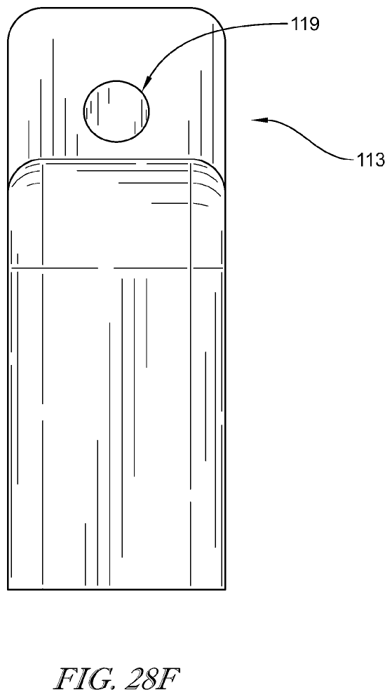

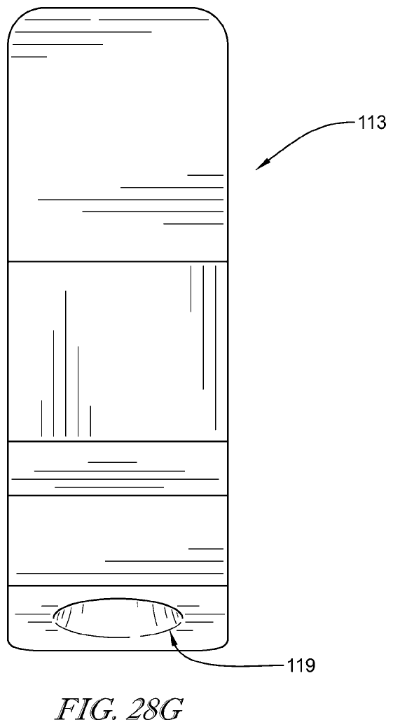

In some embodiments, the clips (113) comprise at least one plastic material that deforms when leveraged onto the flat metal of the dental dam clamp (114) so that the clips (113) snap into place and hold securely on the dental dam clamp (114) for use. Suitable materials for the clips (113) may include polypropylene, polyethylene, or other common injection molded resins. In some embodiments, each clip (113) is formed to include a clamp channel (133) sized to receive a portion of the dental dam clamp (114) therein, as shown in FIGS. 27 and 28A, and two flanges (135) that hold the clip (113) on the dental dam clamp (114). In some embodiments, the area of the clip (113) that mounts onto the dental dam clamp (114) has a length between about 2 mm and about 6 mm and a height between about 0.5 mm and about 2 mm.

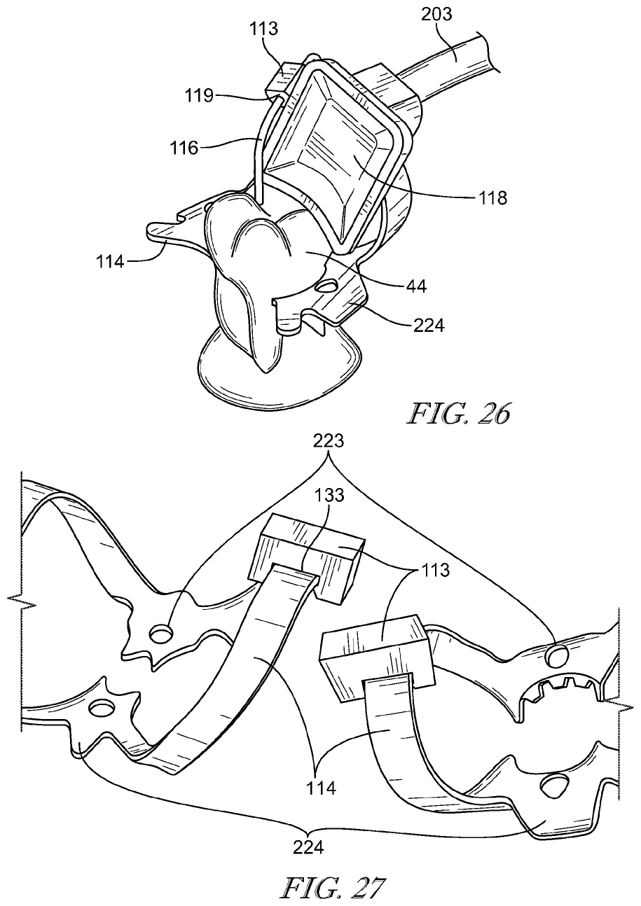

In some embodiments, each of the clips (113) is further formed to include a cannula channel (119) extending through the clip (113) and sized to receive one of the cannulas (115, 116) therein as shown in FIGS. 26 and 28A. The cannula channel (119) extends through the clip (113) at an angle so that the inserted cannula (115, 116) is directed downwardly into the tooth (44). In some embodiments, the cannulas ((115, 116) may be mounted at an angle of about 0° to about 45° for positioning in the workspace of the tooth (44). In some embodiments, the cannulas (115, 116) may be mounted at an angle of about 0° to about 90°.

To limit additional obstruction to the workspace of the tooth (44), the total dimensions of the clips (113) are not greater than an additional 2 mm to 4 mm in each of the aforementioned dimensions.

The cannula channel (119) dimensions are dependent on the desired size of the cannula (115, 116). The cannula channel (119) may be between about 0.25 mm and about 2.0 mm in diameter. The cannula (115, 116) should be held tight enough so as to not move during a procedure but should still allow for adjustment of the cannula (115, 116) position by the operator. The cannula channel (119) may comprise holes that circumferentially surround the cannula (115, 116) requiring tip-end first insertion of the cannulas (115, 116), or the cannula channels (119) may resemble slots with an open side that allow for insertion or snapping in of the cannulas (115, 116) at any point along the cannula length. In some embodiments, the cannula (115, 116) is held within the cannula channel (119) via a friction fit, although other techniques may be used, such as, but not limited to, grommets, O-rings, and other suitable techniques.

The dental dam clamp (114) is formed to include two wings (224) as shown in FIGS. 26 and 27.

Each wing (224) includes a hole (223) extending therethrough. While placed on the tooth (44), the two wings (224) are located on opposing sides of the tooth (44) to locate the tooth (44) therebetween as shown in FIG. 26.

In some embodiments, the kit (200) further comprises an evacuation hood (118) as shown in FIG. 26. The evacuation hood (118) may be used instead of the suction cannula (115), the plastic evacuation tip (207), and/or the long tip (208). The evacuation hood (118) attaches to the dental dam clamp (114) to catch more fluid, including aerosols, than the suction cannula (115), the plastic evacuation tip (207), and/or the long tip (208) catches. While using the evacuation hood (118), the evacuation hood (118) is coupled with the dental dam clamp (114) and the fluid delivery cannula (116) is coupled to the clip (113), which is coupled to the dental dam clamp (114) as shown in FIG. 26.

The evacuation hood (118) may be comprised partially or completely of a flexible material or a compressible material so that the evacuation hood (118) contours to a shape of the tooth (44). In some embodiments, the flexible or otherwise compressible material of the evacuation hood (118) may be foam, silicone, plastic, rubber, elastomeric material, or other suitable material. The flexible and/or compressible material of the evacuation hood (118) allow the evacuation hood (118) to be easily maneuvered and contoured within the oral cavity in certain size constraining locations, while also creating a fluid tight seal between the evacuation hood (118) and the tooth (44). If the evacuation hood (118) is partially made of an elastomeric material, the evacuation hood (118) may be produced using over-molded or by bonding two components together, such as a soft material on a bottom of the rigid structural evacuation hood (118).

The evacuation hood (118) at least partially surrounds the working space defined at the top of the tooth (44) to capture fluid flowing in multiple directions around the tooth (44).

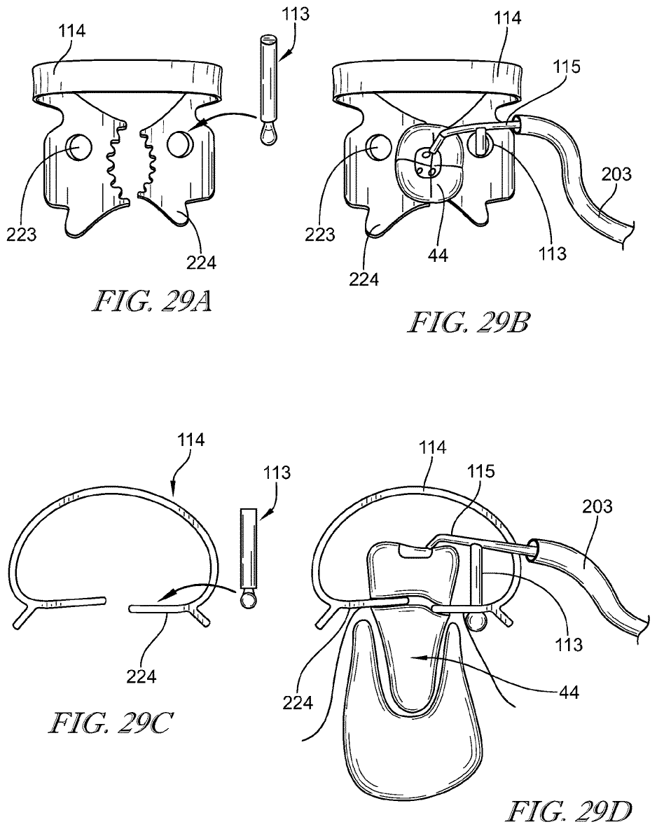

In some embodiments, the plurality of clips (113) may be formed as poles or posts as shown in FIGS. 29A-29D. In such an embodiment, the clips (113) are received in the holes (223) on the wings (224) of the dental dam clamp (114) that are normally used for articulation of the dental dam clamp (114) with pliers. A bottom end of the clip (113) fits securely into one of the holes (223) and a top end of the clip (113) receives the cannula (112) (i.e., the fluid delivery cannula (116)) therein through a hole formed in the top end of the clip (113). The cannula (112) then remains stationary relative to the tooth (44) as shown in FIGS. 29B and 29D.

In some embodiments, the dental dam clamp (114) may be custom made with integral cannula channels (119) that the cannulas (112) or the evacuation hood (118) are snapped or inserted into for use in the procedure. In such an embodiment, the clips (113) may not be necessary.

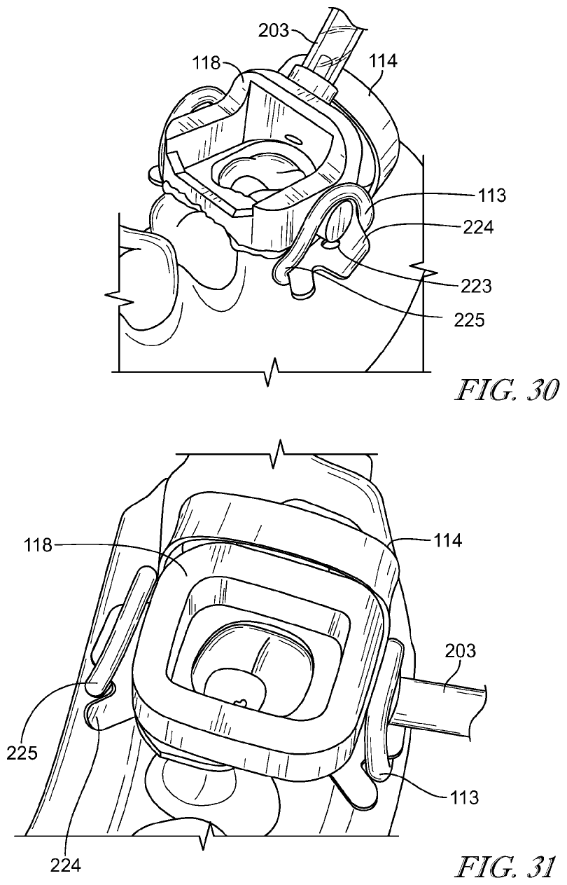

In some embodiments, the clips (113) may each comprise an elastic band (225) configured to stretch over and/or hook onto a portion of the dental dam clamp (114) as shown in FIGS. 30 and 31. In such an embodiment, the elastic band (225) stretches over one of the wings (224) of the dental dam clamp (114) and/or hooks through the hole (223) formed in the wing (224). The elastic band (225) attaches to and/or hooks onto a portion of the evacuation hood (118) that protrudes outwardly away from the tooth (44) and a portion of the dental dam clamp (114) so as to hold the evacuation hood (118) securely to the tooth (44). The elastic bands (225) aid in creating a fluid seal with the tooth (44) by compressing a flexible or otherwise compressible portion of the evacuation hood (118). A portion of the clip (113) or the evacuation hood (118) is braced higher up on the tooth (44) or the dental dam clamp (114).

In some embodiments, the evacuation hood (118) may be between about 5 mm and about 20 mm wide and between about 3 mm and about 10 mm tall. In some embodiments, the evacuation hood (118) may be between about 10 mm and about 20 mm wide. In some embodiments, the evacuation hood (118) may be square shaped or rectangular shaped. In some embodiments, only one suction tube (i.e., the first fluid line (234) or the second fluid line (236)) is connected to the evacuation hood (118) from the tubing assembly (203), however it is conceived that multiple connections may be necessary to pull fluid from the evacuation hood (118), particularly if the evacuation hood (118) surrounds the tooth (44) completely. The one suction tube (234, 236) may be mounted in a rear portion of the evacuation hood (118), as shown in FIG. 30, so the evacuation hood (118) may be mounted on either side of the mouth without the suction tube (234, 236) crossing the mouth to exit. The suction tube (234, 236) may be mounted on a side of the evacuation hood (118) if the evacuation hood (118) is designed symmetrically, so that the evacuation hood (118) may be flipped and used on either side of the mouth as shown in FIG. 31. In some embodiments, the kit (200) may include non-bifurcated tubing and the evacuation hood (118) such that the tubing and the evacuation hood (118) are an evacuation accessory to other irrigation methods, such as standard syringe and needle tip irrigant delivery.

In any of the disclosed embodiments, various components may be omitted or exchanged based on the desired marketing of the kit (100, 200). In some embodiments, the kit (100, 200) may comprise one or more of the following components: an endodontic irrigant or irrigants, a prefilled syringe or syringes containing endodontic irrigants, empty syringes, an instructions for use, an endodontic sealer or sealers, obturation material or materials, a lubricant or lubricants, among other common dental and endodontic products.

The method of using the kit (100, 200) is easily foreseen within the disclosure by attaching various elements to one another as disclosed, attaching at least one kit (100, 200) component to a dental vacuum source, such as the dental office vacuum line (20), and delivering at least one endodontic irrigant in vivo to at least one root canal.

### Definitions

For purposes of interpreting this specification, the following abbreviations, terms and definitions will apply and whenever appropriate, terms used in the singular will also include the plural and vice versa. In the event that any definition set forth below conflicts with any document incorporated herein by reference, the definition set forth below shall control.

The term “treating” refers to administering a therapy in an amount, manner, or mode effective to improve a condition, symptom, or parameter associated with a disorder. In some aspects, treating refers to the treatment of a dental ailment such as an infected tooth.

The term “substantially” as used herein means to a great or significant extent, but not completely.

As used herein, “a”, “an”, “the”, “at least one”, and “one or more” are used interchangeably.

The terms “comprises” and variations thereof do not have a limiting meaning where these terms appear in the description and claims.

The term “patient” or “subject” refers to mammals and humans. Thus, in one aspect, the subject is a mammal, or a mammal in need thereof. In one aspect, the subject is a human, or human in need thereof. In one aspect, the human or human in need thereof is a medical patient. The subject can be from ~0 years of age to 99 years of age or older.

The term “in vivo” generally means in a living subject.

The term “endodontic” generally refers to inside the tooth. The term “endodontic procedure” is generally synonymous with “root canal therapy”, or “root canal procedure”, and refers to a treatment of an infected tooth to cleanse the root canal system and remove the infection.

The term “root canal system” generally refers to the naturally occurring anatomical spaces within the root(s) of a tooth including the pulp chamber. Generally this may be simplified to stating “root canals”.

The above summary of the present invention is not intended to describe each disclosed embodiment or every implementation of the present invention. The description that follows more particularly exemplifies illustrative embodiments. In several places throughout the description, guidance is provided through lists of examples, which examples can be used in various combinations. In each instance, the recited list serves only as a representative group and should not be interpreted as an exclusive list.

1. An endodontic treatment kit comprising:
a tubing assembly that bifurcates into a first fluid line and a second fluid line;
an HVE fitting configured to attach to a dental office vacuum line and connected to the tubing assembly;
a handpiece adjacent an end of the first fluid line in contact with the HVE fitting, wherein the handpiece comprises a luer taper fitting for mating with a first endodontic tip; and
a manifold arranged at an end of the second fluid line in contact with the HVE fitting, wherein the manifold comprises an internal chamber sized to receive a second endodontic tip therein, the second endodontic tip configured to attach to a syringe and protrude from a proximal end of the manifold.

2. The kit of claim 1, further comprising a high-volume evacuator configured to be coupled between the HVE fitting and the dental office vacuum line.

3. The kit of claim 1, further comprising a surgical suction adapter frictionally mated to an evacuation orifice of the high-volume evacuator.

4. The kit of claim 1, comprising a first endodontic tip, a second endodontic tip, and a third endodontic tip, wherein the third endodontic tip differs from both the first endodontic tip and the second endodontic tip.

5. The kit of claim 1, comprising a first endodontic tip, a second endodontic tip, and a third endodontic tip, wherein the third endodontic tip differs from both the first endodontic tip and the second endodontic tip, wherein the first endodontic tip is configured to evacuate fluid away from a root canal of a tooth, and the second endodontic tip is configured to deliver irrigants to the root canal of the tooth.

6. The kit of claim 1, comprising a first endodontic tip, a second endodontic tip, and a third endodontic tip, wherein the third endodontic tip differs from both the first endodontic tip and the second endodontic tip, wherein the first endodontic tip is configured to evacuate fluid away from a root canal of a tooth, and the second endodontic tip is configured to deliver irrigants to the root canal of the tooth, wherein the third endodontic tip is configured to couple with the luer taper fitting of the handpiece and to evacuate fluid away from the root canal of the tooth, and the internal chamber of the manifold is configured to deliver irrigants to the root canal of the tooth.

7. The kit of claim 1, wherein the manifold is comprised of a material having a hardness between about shore 30 and about shore 80.

8. The kit of claim 1, wherein the handpiece comprises a first end and a second end, the first end formed to include the luer taper fitting, and the second end formed as a second tapered end having a diameter of between about 3.5 mm and about 10 mm.

9. The kit of claim 1, wherein the handpiece comprises a first end and a second end, the first end formed to include the luer taper fitting. and the second end formed as a second tapered end having a diameter of between about 3.5 mm and about 10 mm, wherein the handpiece comprises a plurality of exterior ridges between the first end and the second end.

10. The kit of claim 1, wherein the handpiece is between about 20 mm and about 65 mm in length.

11. The kit of claim 1, wherein the HVE fitting is between about 15 mm and about 35 mm in length.

12. The kit of claim 1, wherein the HVE fitting comprises a single outer port and a bifurcated port.

13. The kit of claim 1, wherein the HVE fitting comprises a single outer port and a bifurcated port, wherein the single outer port has exterior dimensions of between about 6 mm and about 15 mm and interior dimensions of between about 2 mm and about 6 mm.

14. An endodontic treatment kit comprising:
a tubing assembly;
an HVE fitting configured to attach a dental office vacuum line to the tubing assembly;
an evacuation cannula in fluid connection with the tubing assembly; and
a first clip configured to attach to a dental dam clamp and to hold the evacuation cannula in a fixed position relative to a tooth so that the evacuation cannula can be positioned in a working space of the tooth.

15. The kit of claim 14, further comprising a dental dam clamp.

16. The kit of claim 14, wherein the tubing assembly comprises a handpiece that is in fluid contact with the HVE fitting, the handpiece comprising a luer taper fitting configured to mate with an endodontic evacuation tip.

17. The kit of claim 14, further comprising a second clip configured to hold an evacuation hood in a fixed position relative to the tooth, the evacuation hood configured to attach to the dental dam clamp while the evacuation hood is in fluid contact with the HVE fitting.

18. (canceled)

19. The kit of claim 14, wherein a portion of the first clip that is in contact with the dental dam clamp is between about 2 mm and about 6 mm in length and between about 0.5 mm and about 2 mm in height.

20. An endodontic treatment kit comprising:
a tubing assembly;
an HVE fitting configured to attach dental office vacuum line to the tubing assembly; and
an evacuation hood configured to be placed on top of a tooth in a fixed position through attachment to the rubber dam clamp, the evacuation hood in fluid contact with the tubing assembly.

21. The kit of claim 20, further comprising a dental dam clamp.

22. (canceled)

23. (canceled)

24. (canceled)

25. (canceled)

26. (canceled)

27. (canceled)
